(19) United States
(12) Patent Application Publication
(10) Pub. No.: US 2004/0141196 A1
(43) Pub. Date: Jul. 22, 2004

(54) Image reproduction system

(76) Inventors: Elmer William Jensen, New Castle, DE (US); Franklin Delano Davis, New Castle, DE (US)

Correspondence Address: Motoko Yuasa, Pacific Ring Service Inc., 1143 Christina Mill Drive, Newark, DE, 19711, US

(21) Appl. No.: 10/712,443

(22) Filed: Nov. 12, 2003

Related U.S. Application Data
(60) Provisional application No. 60/426,177, filed on Nov. 14, 2002.

(51) Int. Cl. H04N 1/60; H04N 1/04

(52) U.S. Cl. 358/1.9; 358/518; 358/475

(57) ABSTRACT

The present invention provides a system for the reproduction of a work of fine art comprising a work of art, which may be a painting, etching, drawing, collage, or any other two dimensional form of fine art, being mounted vertically at a precision distance from a camera, and floodlamps for illuminating said work of art. The floodlamps are computer controlled by feedback from said camera so that intensity, focus, and spread will be even over the full surface of the work of art. The control of the illumination is provided by an illumination computer via optical fiber cables. The present invention also provides the process for reproduction of a work of fine art.

### BACKGROUND OF THE INVENTION

1. Field of the Invention

The invention relates to the reproduction of a work of art, especially two dimensional imagery created by a media such as pencil, charcoal, pastels, acrylics, water color, oils, and photography.

2. Related Art

Colorimetry is a complex science. As defined by the Commission Internationale L'Eclairage (CIE), three primary colors (X, Y, Z) can be combined to define all light sensations 6 experienced by human eyes; that is, the color matching properties of an ideal trichromatic observer defined by specifying three independent functions of wavelength that are identified with the ideal observers color matching functions form an international standard for specifying color. In general, it has been found possible and convenient to represent color stimuli vectors by a three-dimensional special construct, called a tristimulus space or a color space. The fundamentals of such three-dimensional constructs are discussed in the literature.

A variety of trichromatic model systems, such as the red, green, blue (RGB) model; the cyan, magenta, yellow (and black) (CMY(K)) model; the hue, saturation, value (HSV) model; the hue, lightness, saturation (HLS) model; the luminance, red-yellow scale, green-blue scale (L*a*b*) model; the YIQ model used in commercial color television broadcasting; and others, provide alternatives for the system designer.

Color input and output devices, such as scanners, cathode ray tube (CRT) video monitors, and printers, present color images in a device-dependent fashion. For example, CRT guns are driven by RGB values that are stored in a frame buffer. The RGB values index over the color space of each particular model of video monitor. In other words, the color produced by a CRT on a pixel of its screen for a given RGB triplet of values is unique to that device. Because of device design dependency, the RGB triplet may produce a very different color or hue when displayed on a different model CRT and still a different color in a hard copy made with a color printer.

Color transformation (also referred to in the art as color correction and cross-rendering) between model systems in digital data processing presents many problems to the original equipment manufacturer. The transformation of data from one device to another device is difficult because the color matching relationship between the systems are generally non-linear. Therefore, a crucial problem is the maintaining of color integrity between an original image from an input device (such as a color scanner, CRT monitor, digital camera, computer software/firmware generation, and the like) and a translated copy at an output device (such as a CRT monitor, color laser printer, color ink-jet printer, and the like).

Colors can be constructed as renderings of the additive primary colors, red, green, and blue (RGB), or of the subtractive primary colors, cyan, magenta, yellow, and black (CMYK). A transformation may require going from an RGB color space to a CMYK color space. A transformation from one color space to another requires complex, nonlinear computations in multiple dimensions. Since such is not describable mathematically, the use of very large look-up tables containing data to approximate a transformation is generally required to go from an RGB system to a CMYK system to correlate a wide spectrum of color hues. Even then such a table may be constructed which will be correct for the given printer used to construct the table as well as the a given set of printheads, a given ink, and a given substrate. If any of these are changed, the look-up tables will not give the desired transformation.

A color profile describes the color reproduction characteristics of a device specific color space, e.g. scanners, monitors, and output systems, normally on the basis of a colorimetric reference system. Color profiles can also reproduce entire processes including all the individual operations that impact color data. A color profile includes parameters for mathematical operations (gradation curves, matrixes, and tables) that describe the relationship between two color spaces (source color space/destination color space). The profile entries are used by the color management system to convert the source color space to the destination color space and vice versa.

### DESCRIPTION OF PREFERRED EMBODIMENTS

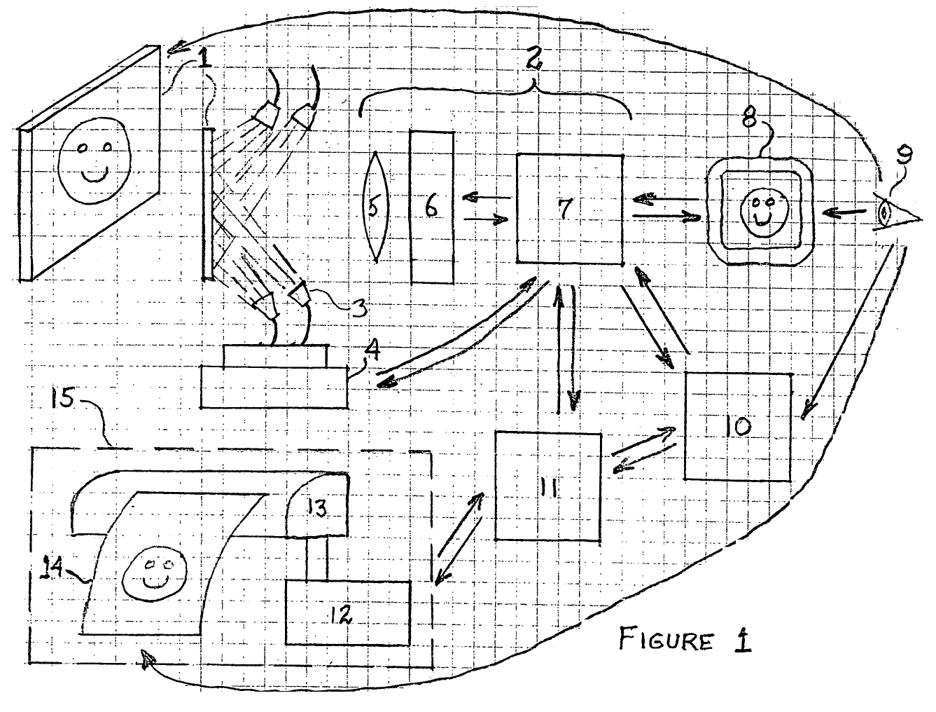

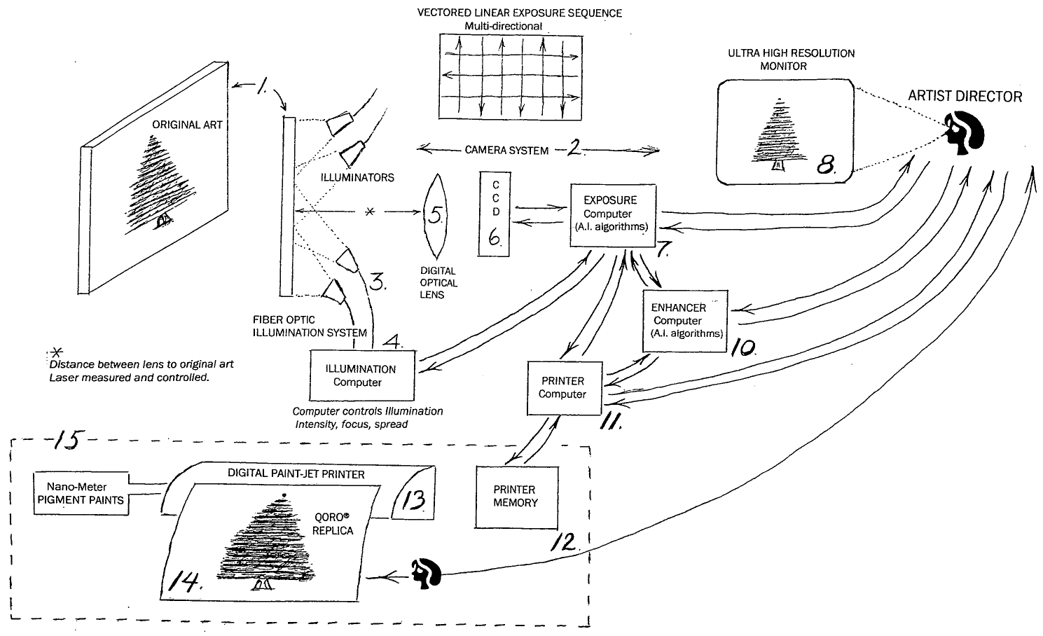

This inventive system for the reproduction of a work of fine art is shown schematically in FIG. 1. The work of art 1, which may be a painting, etching, drawing, collage, or any other two dimensional form of fine art, will preferably be mounted vertically at a precision distance from a camera 2. The work of art 1, is illuminated by floodlamps 3 which preferably will be computer controlled by feedback from the camera 2 so that intensity, focus, and spread will be even over the full surface of the work of art. Such control of the illumination might be provided by an illumination computer 4. Preferably the illumination is provided by optical fiber cables so that the work of art is not subjected to unnecessary infrared and ultraviolet spectra of energy which might harm the art. Illumination systems using generic polymethylmethacrylate cables are available from NoUVIR Research, Seaford, Del.

The process of this invention comprises the steps of capturing the image of a two-dimensional work-of-art in digital form, converting the image from RGB to CMYK color, correcting the CMYK color monitor image, creating a profile for the image for printing of the image on a given substrate using a given ink-jet printing machine with pigment inks, and printing a reproduction of the work-of-art which is visually indistinguishable from the original work-of-art. The present invention provides a method which gives a final product of excellent reproduction. Differences in any area of the image as measured by a spectrophotometer between the original and reproduction are within 5 AE for 95% of the measurements taken. A difference of 5 delta E cannot be detected by the naked eye.

The overall process or reproduction starts with a scanning of the work-of-art using a digital camera 2 so that the original image is not physically contacted. In one embodiment the digital camera 2 might be comprised of a digital optical lens 5, a CCD (Charge Coupled Diode) array 6, and an Exposure Computer 7 to process the digital image. The image, as captured by the CCD array of the camera, is transferred as 14 bits per pixel to an Exposure Computer 7. These bits contain information relating to hue, value, and saturation for each point on the high resolution image obtained by the CCD array 6 of the original image. 512 meg of ram and a graphics accelerator are used for initial image capture. 640 meg of ram and the graphics accelerator are used for rough manipulation of the data, cleaning, and file compression. 1 Gig of ram and the graphics accelerator are used for color correction of the CMYK image derived from the captured RGB image. File compression from 300 Meg to 30 Meg is carried out using “Genuine Fractal” softwear with no loss of resolution

A data processing Enhancer Computer 10 with twin high speed processors, 20 meg hard drive, and 1 Gig of ram is then used to generate a profile and process the rastor image so that the image may be printed with pigment inks on a large format printing system 15. The profiling of the CMYK image on the Ultra High-Resolution Monitor 8 is done automatically and manually by the visual observations by observer 9 of the likeness of the CMYK image to the captured RGB image while the Exposure Computer 7 and the Enhancer Computer 10 stations are linked. “Photoshop”, “Best”, and “Graytag” softwear are used to facilitate the process of color correction of the CMYK image on the Exposure Computer 7 station Ultra High-Resolution Monitor 8 and are used to create the profile which controls the printing of the reproduced work of art via the Printer Computer 11. The profile gives corrections to the printer to make a color which matches the color of the original work of art. Corrections need to be made for any substrate and vary from substrate to substrate. Substrates used for fine art reproductions include canvas and any of the art papers such as water color paper.

The large format printing system 15 is comprised of a printer memory 12, a large format printer head 13, and the art copy 14 which from this inventive process is called a Qorograph™. The large format printing system 15 will preferably use NANO.PIGMENT™ technology in which a matched set of color pigments are provided as separated particles in the same emulsion. A copy made with such pigments will have exceptionally low fading characteristics.

The overall process from image capture to obtaining a reproduction on the pigment printer is about one hour. This makes it feasible to make a reproduction, check it by visual observation and by spectrophotometer to check its likeness to the original, and to make corrections to the profile so that a more accurate reproduction can be made.

The final program for printing a reproduction may be stored in the Printer Computer 11, sent to a computer at another site for reproduction purposes, or stored on a CD disk. Part or all of the final profile might be stored on a printed semiconductor chip under the printed reproduction. The reproduction is thereby marked with its own, unique, profile.

Many methods for incorporating a certification mark in the back of, next to, on, or within an image reproduction already exist. This invention describes a new inventive approach. During the production of an inkjet pigment-jet image, within and below the art image, a separate (or group of) pigment-jet cartridges will deposit a semiconductor element. The semiconductor element/device can be overwritten by the art content so that it is not visible. Each semiconductor identification element can be unique and numbered for each individual image reproduction in a particular limited edition or open edition. The semiconductor identification can be activated and read by applying an electrical or radio frequency impulse from the outside. The image is in no way compromised.

What is claimed is:

1) A system for the reproduction of a work of fine art comprising:
a work of art, which may be a painting, etching, drawing, collage, or any other two dimensional form of fine art, being mounted vertically at a precision distance from a camera; and
floodlamps for illuminating said work of art.

2) The system for reproduction of a work of fine art as set forth in claim 1 wherein said floodlamps are computer controlled by feedback from said camera so that intensity, focus, and spread will be even over the full surface of the work of art.

3) The system for reproduction of a work of fine art as set forth in claim 2 wherein said control of the illumination is provided by an illumination computer.

4) The system for reproduction of a work of fine art as set forth in claim 2 wherein said control of the illumination is provided by optical fiber cables.

5) The process for reproduction of a work of fine art having steps comprising:
capturing the image of a two-dimensional work-of-art in digital form;
converting the image from RGB to CMYK color;
correcting the CMYK color monitor image;
creating a profile for the image for printing of the image on a given substrate using a given ink-jet printing machine with pigment inks; and
printing a reproduction of the work-of-art which is visually indistinguishable from the original work-of-art.
